(19) United States
(12) Patent Application Publication
(10) Pub. No.: US 2026/0255099 A1
(43) Pub. Date: Aug. 27, 2026

(54) ON-WALL SPEAKER SYSTEM

(71) Applicant: Harman International Industries, Incorporated, Stamford, CT (US)

(72) Inventors: An Duc NGUYEN, Simi Valley, CA (US); George E. SHORT, Porter Ranch, CA (US)

(73) Assignee: Harman International Industries, Incorporated, Stamford, CT (US)

(21) Appl. No.: 19/062,305

(22) Filed: Feb. 25, 2025

(51) Int. Cl. H04R 1/26; H04R 1/02; H04R 1/28

(52) U.S. Cl. CPC H04R 1/26; H04R 1/025; H04R 1/026; H04R 1/2811; H04R 2499/15

(57) ABSTRACT

An on-wall speaker system includes a body, a first pair of transducers, and a high frequency actuator element. The body includes a plurality of side walls and a front wall. The first pair of transducers are supported by first opposing side walls of the plurality of side walls. The high frequency actuator element is mounted to the front wall of the body and is configured to induce mechanical vibrations in the front wall to generate high frequency sound waves to a listening environment.

### FIELD

The present disclosure relates to an on wall-speaker system.

### BACKGROUND

The statements in this section merely provide background information related to the present disclosure and may not constitute prior art.

Some speaker systems are mounted onto walls to enhance the listening experience. However, the speakers may transmit mechanical forces onto the wall in which they are mounted. This is especially the case with woofers. The low frequencies at which woofers operate are more likely to cause mechanical forces that may cause the walls to vibrate.

These issues with on-wall speakers, among other issues with on-wall speakers, are addressed by the present disclosure.

### SUMMARY

This section provides a general summary of the disclosure and is not a comprehensive disclosure of its full scope or all of its features.

In one form, the present disclosure provides an on-wall speaker system that includes a body, a first pair of transducers and a high frequency actuator element. The body includes a plurality of side walls and a front wall. The first pair of transducers are supported by first opposing side walls of the plurality of side walls. The high frequency actuator element is mounted to the front wall of the body and is configured to induce mechanical vibrations in the front wall to generate high frequency sound waves to a listening environment.

In variations of the on-wall speaker system of the above paragraph, which can be implemented individually or in any combination: the high frequency actuator element is mounted to the front wall within the body; a second pair of transducers supported by the first opposing side walls of the plurality of side walls; a second pair of transducers supported by second opposing side walls of the plurality of side walls; the first opposing side walls extend perpendicular to the second opposing side walls; the first opposing side walls are lateral side walls of the body and the second opposing side walls are upper and lower side walls of the body; the first pair of transducers are speakers selected from a group consisting of a subwoofer and woofer; the high frequency actuator element is an electromechanical actuator; the first pair of transducers are passive transducers or active transducers; a display coupled to the front wall of the body, or the front wall may be composed of a display element such as artwork, photograph, or an active display screen, module, or touchscreen; a bracket coupled to a back wall of the body and configured to mount the body to a wall of the listening environment; and an additional transducer or group of transducers may be mounted on the side(s) or top of the cabinet and these additional transducers may be configured to reproduce sound from an additional audio channel or channels, such as surround sound channels, or height channels, for example.

In another form, the present disclosure provides an on-wall speaker system that includes a body, a first pair of transducers and a high frequency actuator element. The body includes a plurality of side walls and a front wall extending perpendicular to the side walls. The first pair of transducers are supported by first opposing side walls of the plurality of side walls. The first pair of transducers face away from each other. The high frequency actuator element is located within the body and mounted to the front wall of the body. The high frequency actuator element is configured to induce mechanical vibrations in the front wall to generate high frequency sound waves to a listening environment.

In variations of the on-wall speaker system of the above paragraph, which can be implemented individually or in any combination: the high frequency actuator element is an electromechanical actuator; a second pair of transducers supported by the first opposing side walls of the plurality of side walls; a second pair of transducers supported by second opposing side walls of the plurality of side walls; the first pair of transducers are passive transducers or active transducers; a display module coupled to the front wall of the body, or the front wall of the body is composed of a display element such as artwork, photographs, or an active display screen, module, or touchscreen; and a bracket coupled to a back wall of the body and configured to mount the body to a wall of the listening environment.

In yet another form, the present disclosure provides an on-wall speaker system that includes a body, a bracket, first and second pair of transducers and a high frequency actuator element. The body includes a plurality of side walls, a back wall, and a front wall. The front wall defines a front face facing a listening environment. The plurality of side walls, the back wall, and the front wall defining an acoustic chamber. The bracket is coupled to the back wall and is configured to mount the body to a wall of the listening environment. The first pair of transducers are supported by first opposing side walls of the plurality of side walls. The first pair of transducers face away from each other. The second pair of transducers are supported by second opposing side walls of the plurality of side walls that extend perpendicular to the first opposing side walls. The second pair of transducers face away from each other. The high frequency actuator element is located within the body and is mounted to the front wall of the body. The high frequency actuator element includes an electromechanical actuator configured to induce mechanical vibrations in the front wall to generate high frequency sound waves to a listening environment. In one or more embodiments, the first pair of transducers are passive transducers or active transducers.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a listening environment including a plurality of on-wall speaker systems according to the principles of the present disclosure;

FIG. 2 is a perspective view of one of the on-wall speaker systems of FIG. 1;

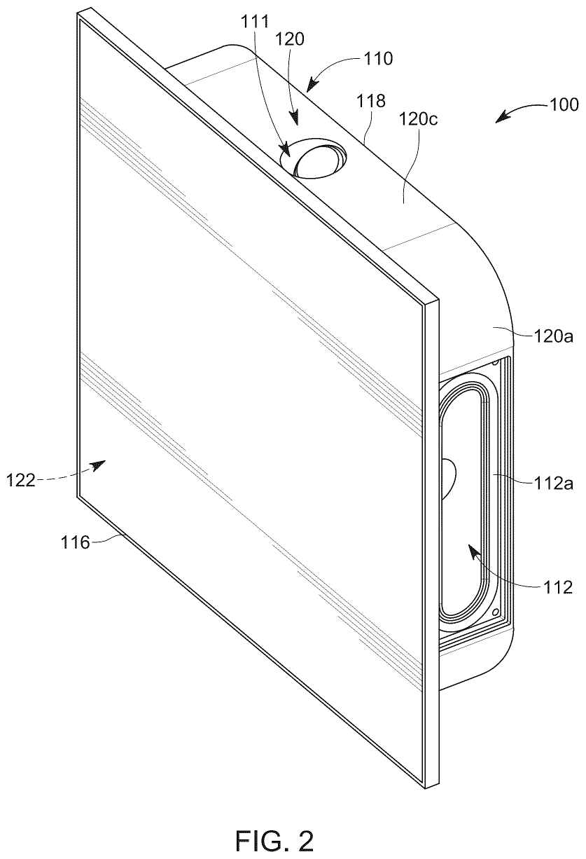

FIG. 3 is a perspective view of the on-wall speaker system of FIG. 2 with a pair of transducers of the on-wall speaker system exploded from a cabinet of the on-wall speaker system;

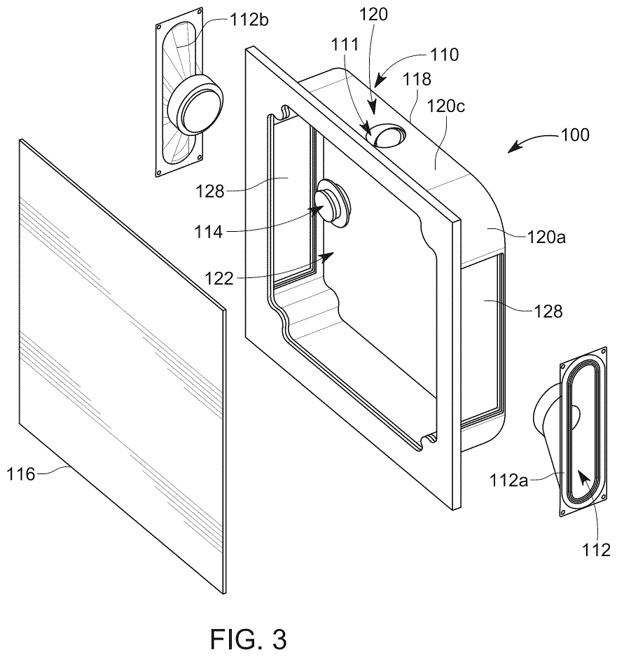

FIG. 4 is a side view of the on-wall speaker system of FIG. 2;

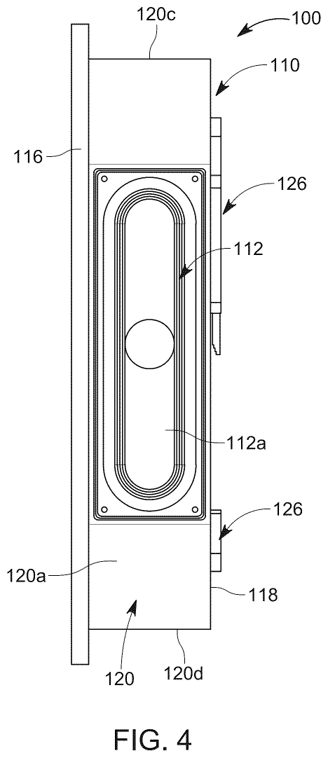

FIG. 5 is a perspective view of the on-wall speaker system with a front wall of the on-wall speaker system removed for clarity;

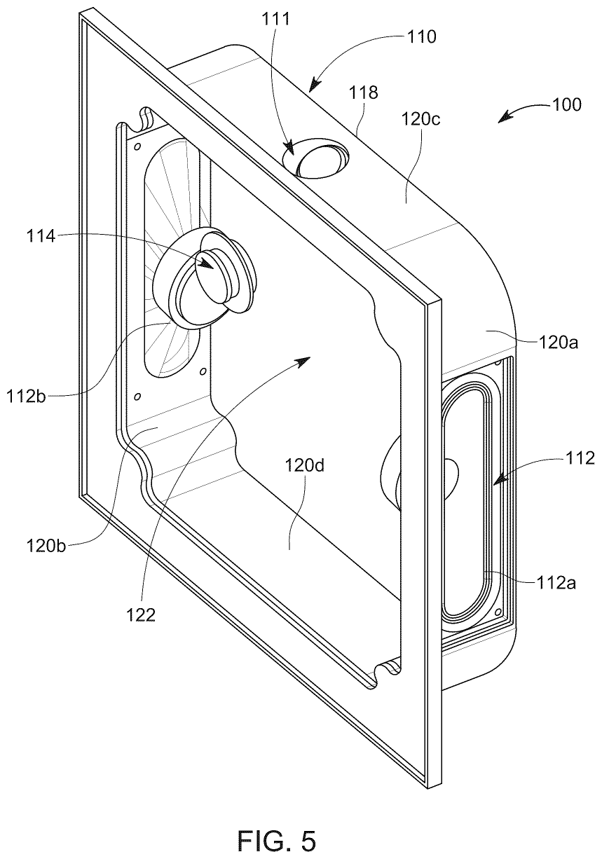

FIG. 6 is a cross-sectional view of the on-wall speaker system of FIG. 2;

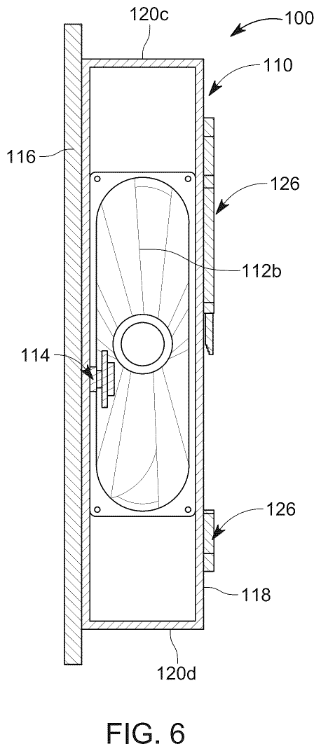

FIG. 7 is a perspective view of another on-wall speaker system according to the principles of the present disclosure;

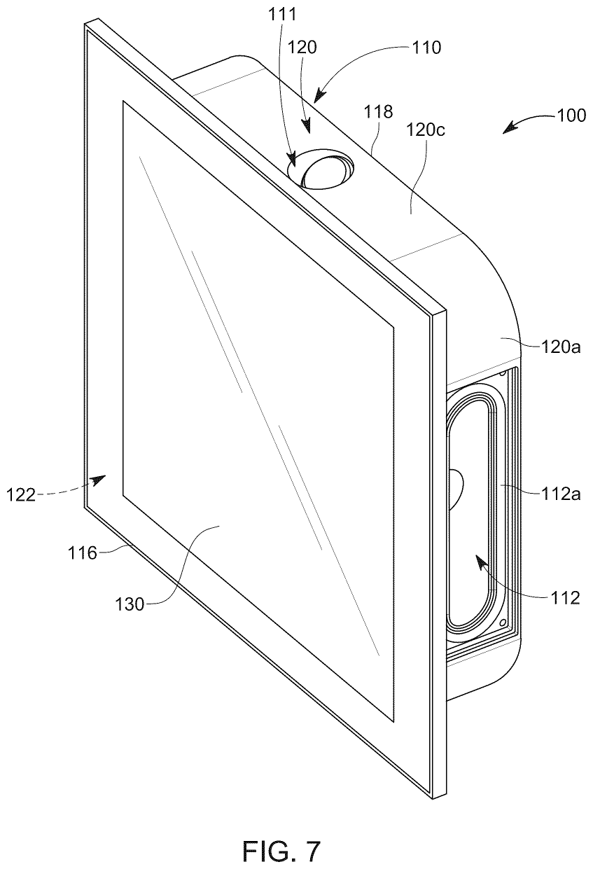

FIG. 8 is a perspective view of another on-wall speaker system according to the principles of the present disclosure with a front wall removed for clarity; and

FIG. 9 a side view of yet another on-wall speaker system according to the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

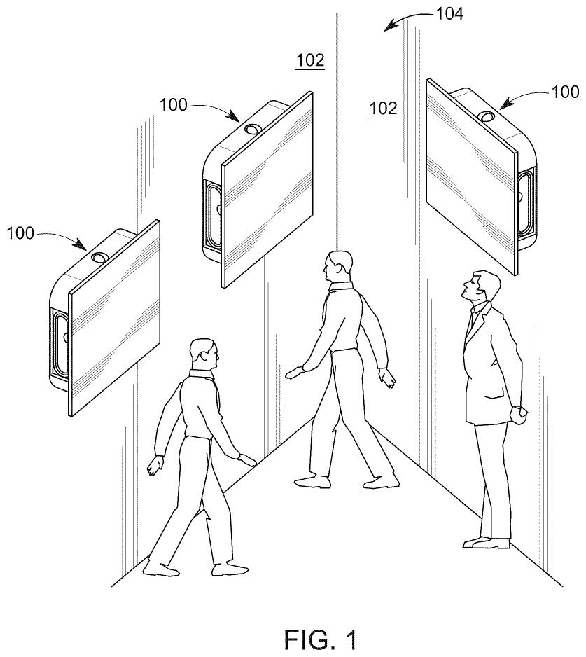

With reference to FIG. 1, an on-wall speaker system 100 is illustrated. The on-wall speaker system 100 is mounted onto an outer surface of a wall 102 of a listening environment 104 (e.g., a room). In this way, a distance exists between the speaker system 100 and a floor of the listening environment 104, and the wall 102 (e.g., studs inside of a wall) supports the speaker system 100 above the floor. When the on-wall speaker system 100 is mounted to the wall 102 of the listening environment 104, the entire speaker system 100 is visible in the listening environment 104. In the example illustrated, the speaker system 100 includes a cabinet or body 110, a pair of transducers 112a, 112b (together referred to as the pair of transducers 112), and one or more high frequency actuator devices or elements 114 (shown schematically in the figures).

The body 110 includes a front wall 116, a back wall 118, and a plurality of side walls 120a, 120b, 120c,120d (together referred to as the sides 120). In the example illustrated, the front wall 116, the back wall 118, and the side walls 120 cooperate with each other to define an acoustic chamber 122 that houses the high frequency actuator device 114 and at least a portion of the transducers 112, which will be described in more detail below. The front wall 116 faces in a direction that is towards the occupants in the listening environment 104. In this way, the high frequency actuator device 114 induces mechanical vibrations in the front wall 116 and the vibrating front wall 116 creates sounds in the listening environment 104. In the example illustrated, the front wall 116 has a surface area that is greater than a surface area of the side walls 120 and greater than a surface area of the back wall 118. In one or more embodiments, the surface area of the front wall 116 may be equal to the surface area of the back wall 118. The front wall 116 extends parallel to the back wall 118 and extends perpendicular to the sides 120. In the example illustrated, the front wall 116 is a solid, uniform structure that does not include cutouts or openings. In this way, the sound waves from the high frequency actuator device 114 travel through the structure of the front wall 116 and into the listening environment 104. The front wall 116 includes a front face 116a that faces away from the acoustic chamber 122 and a rear face 116b that faces towards the acoustic chamber 122.

The back wall 118 is mounted onto the outer surface of a wall 102 of a listening environment 104 (e.g., a room) such that the wall 102 supports the entire speaker system 100 above the floor. In the example illustrated, a bracket assembly 126 is mounted to the back wall 118 and onto the wall 102 of the listening environment 104. The side walls 120 form an outer periphery of the body 110 and are configured to support the pair of transducers 112. The side walls 120a, 120b opposed to each other and are lateral side walls. The side wall 120c is an upper side wall and is opposed to the side wall 120d, which is a lower side wall. In the example illustrated, each of the side walls 120a, 120b has a cutout 128, which is configured to receive a respective transducer 112 of the pair of transducers 112. In one or more embodiments, each of the side walls 120c, 120d may have a cutout, which receives a respective transducer of another pair of transducers.

In the example illustrated, the pair of transducers 112a, 112b are mounted and supported in the cutouts 128 of the side walls 120a, 120b opposite each other and face away from each other. That is, the transducer 112a is mounted in the cutout 128 of the side wall 120a and the transducer 112b is mounted in the cutout 128 of the side wall 120b. The pair of transducers 112a, 112b may be received in the chamber 122 and may be speakers having a diaphragm surface that generates sound by its vibration (i.e., the speakers operate at low frequencies which are more likely to cause vibrations). The diaphragm surfaces of the pair of transducers 112a, 112b are positioned perpendicular to the front wall 116 of the body 110 to project sound away from each other and into the listening environment 104. The pair of transducers 112a, 112b are mounted so that the sound generating surfaces face away from each other. In this way, opposing forces are advantageously cancelled out inside the body 110, which inhibits vibration of the on-wall speaker system 100 and the wall supporting the speaker system 100.

In the example illustrated, the pair of transducers 112a, 112b may be active transducers, passive transducers, or a combination of active and passive transducers. The active transducers may be subwoofer speakers, for example. The passive transducers may be subwoofer speakers without an active element. That is, the passive transducers include a diaphragm surface to radiate sound with its vibration, but does not include an excitation coil connected to an audio signal source included in active transducers. The passive transducers may be excited by sound pressure radiation generated by active transducers, for example. An additional transducer or group of transducers (not shown) may be mounted on the side(s) 120a or top 120b of the cabinet 110 and these additional transducers may be configured to reproduce sound from an additional audio channel 111 or channels, such as surround sound channels, or height channels, for example.

The high frequency actuator device 114 is mounted to the front wall 116 of the body 110 and configured to generate high frequency sound waves to the listening environment 104. In one or more examples, the high frequency sound waves may be between 400 hertz-20,000 hertz and may direct the sound waves to a predetermined location of the listening environment 104. In the example illustrated, the high frequency actuator device 114 is mounted to an inside surface of the front wall 116 within the acoustic chamber 122. In some forms, the high frequency actuator device 114 may be mounted to an outside surface of the front wall 116 and located external to the acoustic chamber 122. In the example illustrated, the high frequency actuator device 114 is an electromechanical actuator that vibrates the front wall 116 of the body 110, thereby permitting the system 100 to provide high frequencies and act as a distributed mode loudspeaker (DML). Stated differently, when caused to vibrate by the actuator device 114, the front wall 116 acts to amplify these vibrations such that system 100 produces sound. The actuator device 114 converts an electrical signal into a mechanical vibration, which creates a vibration of the front wall 116 of the body 110.

In one or more embodiments, the high frequency actuator device 114 is driven by an electrical signal received at terminals thereof from, for example, an audio amplifier unit (not shown) via cables (not shown). The high frequency actuator device 114 includes, inter alia, a driver portion (not shown) that directly reciprocates the front wall 116 of the body 110.

The front wall 116 of the on-wall speaker system 100 may optionally be composed of a display element 130. In one form, the display element 130 may be an artwork. In another form, the display element 130 may be a photograph. In yet another form, the display element 130 may be an active display screen, module, or a touchscreen. In one or more embodiments, the display module may be a touchscreen and can include functionality wherein the touchscreen is engageable by a user via a captive touch. The display module 130 may be at least one of a liquid crystal display (LCD), an organic light-emitting diode (OLED), and a quantum light-emitting diode (QLED) display, for example. In one or more embodiments, the display module is made of a non-conductive material such as glass or plastic, for example. In one or more embodiments, the display module may be transparent or opaque. The display module may cover an entire outside surface of the front wall 116. In some forms, the display module may cover a portion of the surface of the front wall 116 that is less than the entire surface.

The on-wall speaker system 100 of the present disclosure provides the advantage of reducing components of the system 100, which reduces the weight of the system 100. For example, the cancellation of vibration and noise between the pair of transducers 112a, 112b allows for acoustic isolator members or plates to be eliminated from the system 100. That is, acoustic isolator members typically would inhibit vibration from the transducers from traveling to the high frequency device. Given the cancellation of the vibration and noise, the acoustic isolator members may be eliminated from the on-wall speaker system of the present disclosure. It should be understood that other components such as amplifiers, additional speakers, etc may be located within the chamber 122 of the system 100 without departing from the scope of the present disclosure.

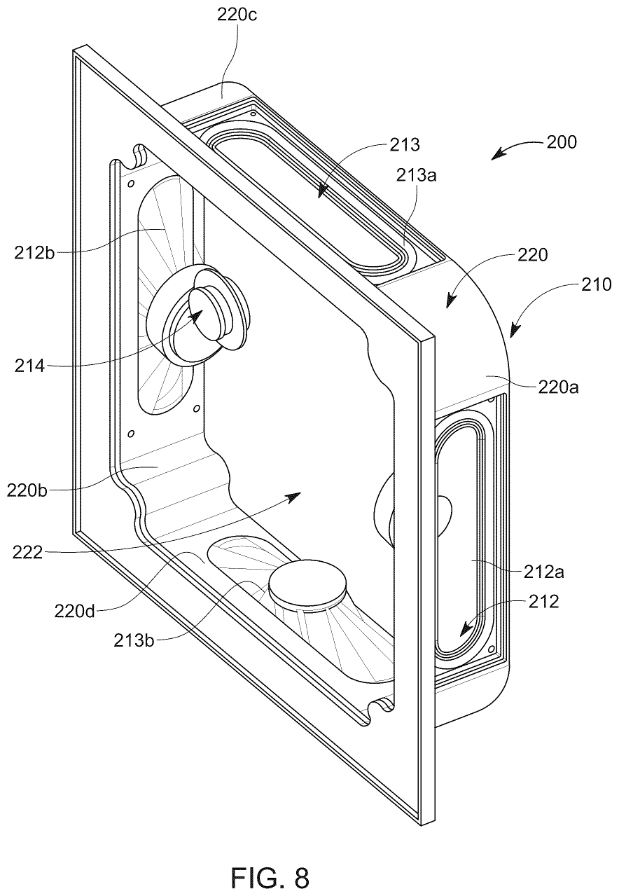

With reference to FIG. 8, another on-wall speaker system 200 is provided. The structure and function of the on-wall speaker system 200 may be similar or identical to that of the on-wall speaker system 100 described above, apart from any exception noted below.

In the example illustrated, the speaker system 200 includes a cabinet or body 210, a pair of first transducers 212a, 212b (together referred to as the pair of transducers 212), a pair of second transducers 213a, 213b (together referred to as the pair of transducers 213), and one or more high frequency devices or elements 214. The body 210 includes a front wall 216, a back wall 218, and a plurality of side walls 220a, 220b, 220c, 220d (together referred to as the sides 220). In the example illustrated, the front wall 216, the back wall 218, and the side walls 220 cooperate with each other to define an acoustic chamber 222 that houses the high frequency system and at least a portion of the transducers 212, 213.

The structure and function of the transducers 212, 213 may be similar or identical to that of the transducers 112 described above, and therefore, will not be described again in detail. In the example illustrated, the pair of transducers 212a, 212b are mounted and supported in the cutouts of the side walls 220a, 220b opposite each other and face away from each other. In this way, opposing forces are advantageously cancelled out inside the body 210, which inhibits vibration and noise of the on-wall speaker system 200 and the wall supporting the speaker system 200. Similarly, the pair of transducers 213a, 213b are mounted and supported in the cutouts of the side walls 220c, 220d opposite each other and face away from each other. In this way, opposing forces are advantageously cancelled out inside the body 210, which inhibits vibration of the on-wall speaker system 200 and the wall supporting the speaker system 200.

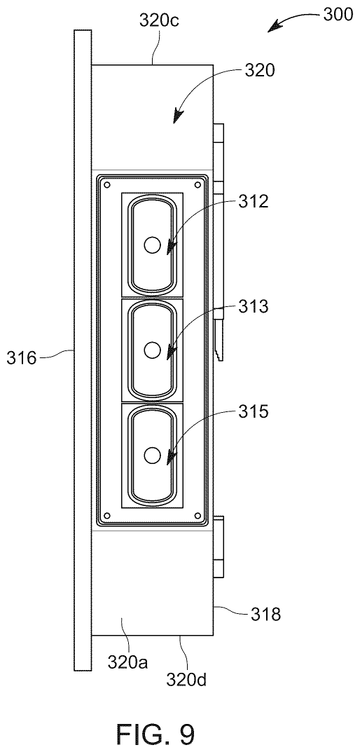

With reference to FIG. 9, another on-wall speaker system 300 is provided. The structure and function of the on-wall speaker system 300 may be similar or identical to that of the on-wall speaker systems 100, 200 described above, apart from any exception noted below.

In the example illustrated, the speaker system 300 includes a cabinet or body 310, a plurality of pairs of transducers 312 (only one shown in the figures), 313 (only one shown in the figures), 315 (only one shown in the figures), and one or more high frequency devices or elements (not shown). The body 310 includes a front wall 316, a back wall 318, and a plurality of side walls 320a, 320c, 320d (together referred to as the sides 320). In the example illustrated, the front wall 316, the back wall 318, and the side walls 320 cooperate with each other to define an acoustic chamber 322 that houses the high frequency system and at least a portion of the transducers 312, 313, 315.

The structure and function of the transducers 312, 313, 315 may be similar or identical to that of the transducers 112 described above, and therefore, will not be described again in detail. In the example illustrated, the pair of transducers 312 are mounted and supported in first cutouts of the side walls 320a opposite each other and face away from each other. In this way, opposing forces are advantageously cancelled out inside the body 310, which inhibits vibration and noise of the on-wall speaker system 300 and the wall supporting the speaker system 300. The pair of transducers 313 are mounted and supported in second cutouts of the side walls 320a opposite each other and face away from each other. In this way, opposing forces are advantageously cancelled out inside the body 310, which inhibits vibration of the on-wall speaker system 300 and the wall supporting the speaker system 300. The pair of transducers 315 are mounted and supported in third cutouts of the side walls 320a opposite each other and face away from each other. In this way, opposing forces are advantageously cancelled out inside the body 310, which inhibits vibration of the on-wall speaker system 300 and the wall supporting the speaker system 300.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. An on-wall speaker system comprising:
a body including a plurality of side walls and a front wall;
a first pair of transducers supported by first opposing side walls of the plurality of side walls; and
a high frequency element mounted to the front wall of the body and configured to induce mechanical vibrations in the front wall to generate high frequency sound waves to a listening environment.

2. The on-wall speaker system of claim 1, wherein the high frequency element is mounted to the front wall within the body.

3. The on-wall speaker system of claim 1, further comprising a second pair of transducers supported by the first opposing side walls of the plurality of side walls.

4. The on-wall speaker system of claim 1, further comprising a second pair of transducers supported by second opposing side walls of the plurality of side walls.

5. The on-wall speaker system of claim 4, wherein the first opposing side walls extend perpendicular to the second opposing side walls.

6. The on-wall speaker system of claim 4, wherein the first opposing side walls are lateral side walls of the body and the second opposing side walls are upper and lower side walls of the body.

7. The on-wall speaker system of claim 1, wherein the first pair of transducers are speakers selected from a group consisting of a subwoofer and woofer.

8. The on-wall speaker system of claim 1, wherein the high frequency element is an electromechanical actuator.

9. The on-wall speaker system of claim 8, wherein the first pair of transducers are passive transducers or active transducers.

10. The on-wall speaker system of claim 1, wherein the front wall comprises a display element including at least one of an artwork, a photograph, a display module, or touchscreen.

11. The on-wall speaker system of claim 1, further comprising a bracket coupled to a back wall of the body and configured to mount the body to a wall of the listening environment.

12. An on-wall speaker system comprising:
a body including a plurality of side walls and a front wall extending perpendicular to the plurality of side walls;
a first pair of transducers supported by first opposing side walls of the plurality of side walls, the first pair of transducers facing away from each other; and
a high frequency element located within the body and mounted to the front wall of the body, the high frequency element configured to induce mechanical vibrations in the front wall to generate high frequency sound waves to a listening environment.

13. The on-wall speaker system of claim 12, wherein the high frequency element is an electromechanical actuator.

14. The on-wall speaker system of claim 12, further comprising a second pair of transducers supported by the first opposing side walls of the plurality of side walls.

15. The on-wall speaker system of claim 12, further comprising a second pair of transducers supported by second opposing side walls of the plurality of side walls.

16. The on-wall speaker system of claim 12, wherein the first pair of transducers are passive transducers or active transducers.

17. The on-wall speaker system of claim 12, wherein the front wall comprises a display element including at least one of an artwork, a photograph, a display module, or a touchscreen.

18. The on-wall speaker system of claim 12, further comprising a bracket coupled to a back wall of the body and configured to mount the body to a wall of the listening environment.

19. An on-wall speaker system comprising:
a body including a plurality of side walls, a back wall, and a front wall, the front wall defining a front face facing a listening environment, the plurality of side walls, the back wall, and the front wall defining an acoustic chamber;
a bracket coupled to the back wall and configured to mount the body to a wall of the listening environment;
a first pair of transducers supported by first opposing side walls of the plurality of side walls, the first pair of transducers facing away from each other;
a second pair of transducers supported by second opposing side walls of the plurality of side walls that extend perpendicular to the first opposing side walls, the second pair of transducers facing away from each other; and
a high frequency element located within the body and mounted to the front wall of the body, the high frequency element comprising an electromechanical actuator configured to induce mechanical vibrations in the front wall to generate high frequency sound waves to a listening environment.

20. The on-wall speaker system of claim 19, wherein the first pair of transducers are passive transducers or active transducers.
